(19) United States
(12) Patent Application Publication
(10) Pub. No.: US 2020/0301463 A1
(43) Pub. Date: Sep. 24, 2020

(54) CYCLIC STICK SUPPORT AND FRICTION ADJUSTMENT

(71) Applicant: Bell Helicopter Textron Inc., Fort Worth, TX (US)

(72) Inventors: Joshua Rogers, North Richland Hills, TX (US); Joshua Emrich, Grapevine, TX (US)

(73) Assignee: Bell Helicopter Textron Inc., Fort Worth, TX (US)

(21) Appl. No.: 16/361,345

(22) Filed: Mar. 22, 2019

(51) Int. Cl. G05G 9/047; B64C 13/04

(52) U.S. Cl. CPC G05G 9/047; G05G 2700/16; G05G 2009/04707; B64C 13/0421

(57) ABSTRACT

Embodiments are directed to a flight control stick support comprising a spherical bearing coupled to a flight control stick, a first plate having a first hole configured to receive a top portion of the spherical bearing, a second plate having a second hole configured to receive a bottom portion of the spherical bearing, and a clamping device configured to move the first plate relative to and the second plate to apply a variable force against the spherical bearing.

### BACKGROUND

A rotorcraft may include one or more rotor systems. One example of a rotor system is a main rotor system on the rotorcraft. A main rotor system may generate aerodynamic lift to support the weight of the rotorcraft in flight and may generate thrust to counteract aerodynamic drag and move the rotorcraft in forward flight. Another example of a rotorcraft rotor system is a tail rotor system. A tail rotor system may generate thrust in the same direction as the main rotor system's rotation to counter the torque effect created by the main rotor system and to keep the rotorcraft's fuselage aligned in a desired direction.

Rotorcraft have flight control systems that allow pilots to control the main and tail rotor systems. Flight control systems comprise a collection of mechanical linkages and equipment connecting cockpit controls, such as a collective, a cyclic, and rudder pedals, to flight control surfaces that allow a rotorcraft to be flown with precision and reliability. For example, the rotorcraft flight control system controls operation (e.g. pitch) of the rotor blades through a swash plate component. The rotorcraft's flight control system is critical to flight safety.

### SUMMARY

Embodiments are directed to a flight control device comprising a grip, a stick associated with the grip, and a gimbal. The gimbal comprises a spherical bearing coupled to the stick, a first plate having a first hole configured to receive a top portion of the spherical bearing, and a second plate having a second hole configured to receive a bottom portion of the spherical bearing, wherein the first plate and the second plate are configured to move relative to each other to apply a variable force against the spherical bearing. The first hole further comprises a first inner surface, and the second hole comprises a second inner surface. The variable force against the spherical bearing may be applied by mechanical interaction between the first and second inner surfaces and a surface of the spherical bearing.

The flight control device further comprises a clamping device coupled to the first plate and the second plate, wherein the clamping device is configured to move the first plate and the second plate relative to each other. The clamping device may comprise a knob portion configured to receive a bolt portion. The knob is positioned to apply a force against the first plate, and the bolt portion is positioned to apply a force against the second plate. Turning the knob portion in a first direction reduces a distance between the first plate and the second plate. Turning the knob portion in a second direction opposite the first direction increases the distance between the first plate and the second plate. The clamping device may be selected from a mechanical clamp, an electronic motor, and a hydraulic actuator.

The first plate and the second plate may be configured to remain in a generally parallel relationship as they move relative to each other. Alternatively, a first end of the first plate and a first end of the second plate may be configured to remain at a fixed distance from each other, and a second end of the first plate and a second end of the second plate may be configured to move relative to each other to apply a variable force against the spherical bearing.

The flight control device may further comprise a lever coupled to the spherical bearing at a position opposite to the stick. The lever may be configured to be coupled to a flight control linkage. The flight control device may further comprise a cyclic stop coupled to the second plate, and a bump stop coupled to the spherical bearing and the lever, wherein the cyclic stop and the bump stop are configured to limit a range of motion of the spherical bearing.

### BRIEF DESCRIPTION OF THE DRAWINGS

Having thus described the invention in general terms, reference will now be made to the accompanying drawings, which are not necessarily drawn to scale, and wherein:

FIG. 1 depicts a rotorcraft according to an example embodiment.

FIG. 2 depicts an example embodiment of a flight control device, such as a cyclic control assembly.

FIG. 3A depicts an example prior art cyclic stick support with a friction adjustment.

FIG. 3B is a cross-section view of the prior art cyclic stick support shown in FIG. 3A.

FIG. 4A depicts an example cyclic stick support with improved friction adjustment according to one embodiment.

FIG. 4B is a cross-section view of the cyclic stick support shown in FIG. 4A.

FIG. 5A depicts an example cyclic stick support with improved friction adjustment according to an alternative embodiment.

FIG. 5B is a side view of the cyclic stick support shown in FIG. 5A.

While the system of the present application is susceptible to various modifications and alternative forms, specific embodiments thereof have been shown by way of example in the drawings and are herein described in detail. It should be understood, however, that the description herein of specific embodiments is not intended to limit the system to the particular forms disclosed, but on the contrary, the intention is to cover all modifications, equivalents, and alternatives falling within the spirit and scope of the present application as defined by the appended claims.

### DETAILED DESCRIPTION

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

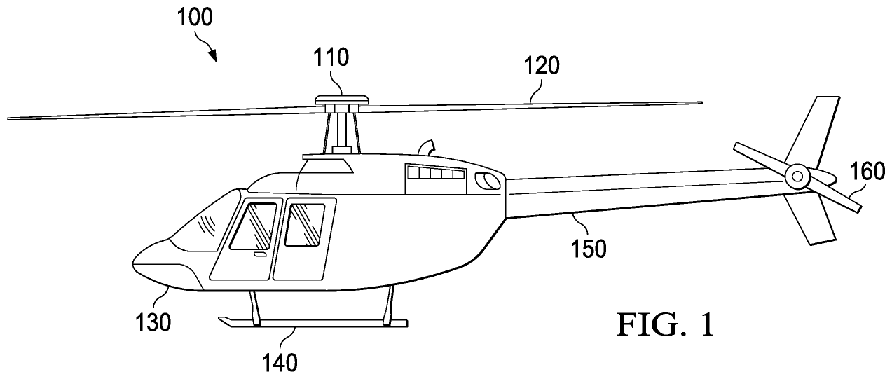

FIG. 1 depicts a rotorcraft 100 according to an example embodiment. Rotorcraft 100 features a rotor system 110, blades 120, a fuselage 130, a landing gear 140, and an empennage 150. Rotor system 110 couples torque from an engine (not shown) to blades 120 and causes the blades 120 to rotate. Rotor system 110 may include a flight control system for selectively controlling the pitch of each blade 120 in order to selectively control direction, thrust, and lift of rotorcraft 100. Fuselage 130 represents the body of rotorcraft 100 and may be coupled to rotor system 110 such that rotor system 110 and blades 120 may move fuselage 130 through the air. Landing gear 140 supports rotorcraft 100 when rotorcraft 100 is landing and/or when rotorcraft 100 is at rest on the ground. Empennage 150 represents the tail section of the aircraft and features components of a rotor system and blades 160. Blades 160 may provide thrust in the same direction as the rotation of blades 120 to counter the torque effect created by rotor system 110 and blades 120. The teachings of certain embodiments relating to rotor systems as described herein may apply to rotor system 110 and/or other rotor systems, such as other tilt rotor and helicopter rotor systems. It should also be appreciated that teachings from rotorcraft 100 may apply to aircraft other than rotorcraft, such as airplanes and unmanned aircraft, to name a few examples.

A pilot may manipulate one or more pilot flight control devices in order to achieve controlled aerodynamic flight. Inputs provided by the pilot to the pilot flight control devices may be transmitted mechanically and/or electronically (e.g., via a fly-by-wire flight control system) to flight control systems. Flight control systems may represent devices operable to change the flight characteristics of the aircraft. Examples of flight control systems on rotorcraft 100 may include the control system operable to change the positions (e.g., pitch) of blades 120 and blades 160.

Rotorcraft 100 may feature at least three sets of pilot flight control devices: a collective control assembly, a cyclic control assembly, and a pedal assembly. Although examples discussed herein describe pilot flight controls such as cyclic control assemblies, collective control assemblies, and pedal assemblies, teachings of certain embodiments recognize that other pilot flight controls may be used. For example, in some embodiments, a tiltrotor aircraft may include a power control device, and a thrust control device.

In general, cyclic pilot flight controls may allow a pilot to impart cyclic motions on blades 120. Cyclic motions in blades 120 may cause rotorcraft 100 to tilt in a direction specified by the pilot. For tilting forward and back (pitch) and/or tilting sideways (roll), the angle of attack or pitch of blades 120 may be altered cyclically during rotation, creating different amounts of lift at different points in the cycle.

Collective pilot flight controls may allow a pilot to impart collective motions on blades 120. Collective motions in blades 120 may change the overall lift produced by blades 120. For increasing or decreasing overall lift in blades 120, the angle of attack or pitch for all blades 120 may be collectively altered by equal amounts at the same time resulting in ascents, descents, acceleration, and deceleration.

Anti-torque pilot flight controls may allow a pilot to change the amount of anti-torque force applied to rotorcraft 100. As explained above, blades 160 may provide thrust in the same direction as the rotation of blades 120 to counter the torque effect created by rotor system 110 and blades 120. Anti-torque pilot flight controls may change the amount of anti-torque force applied to change the heading of rotorcraft 100. For example, providing anti-torque force greater than the torque effect created by rotor system 110 and blades 120 may cause rotorcraft 100 to rotate in a first direction, whereas providing anti-torque force less than the torque effect created by rotor system 110 and blades 120 may cause rotorcraft 100 to rotate in an opposite direction. In some embodiments, anti-torque pilot flight controls may change the amount of anti-torque force applied by changing the pitch of blades 160, increasing or reducing the thrust produced by blades 160 and causing the nose of rotorcraft 100 to yaw in the direction of the applied pedal. In some embodiments, rotorcraft 100 may include additional or different anti-torque devices, such as a rudder or a NOTAR (no tail rotor) anti-torque device, and the anti-torque flight controls may change the amount of force provided by these additional or different anti-torque devices.

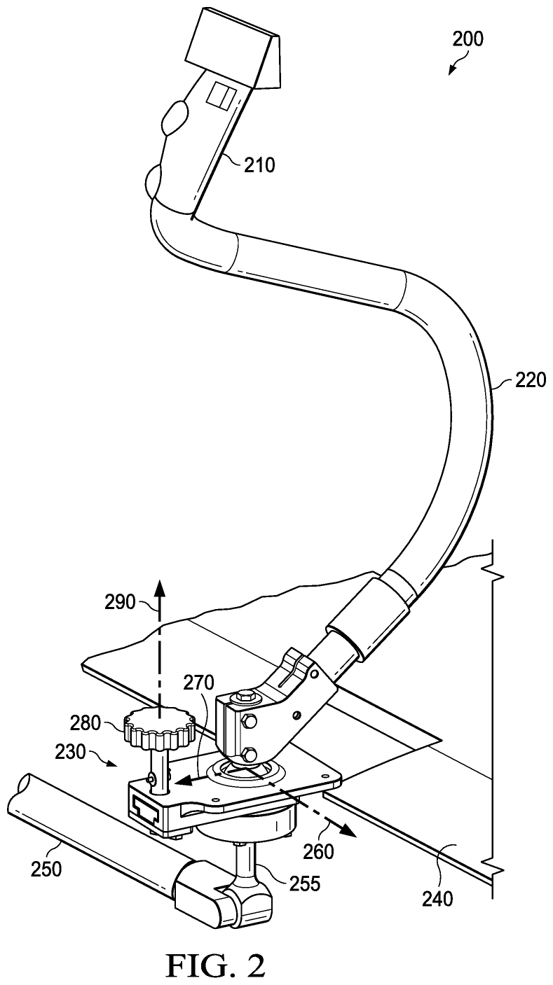

FIG. 2 depicts an example embodiment of a flight control device 200, such as a cyclic control assembly. Flight control device 200 may feature a grip 210, stick 220, and gimbal assembly 230. The gimbal assembly 230 may be mounted on the floor 240 of an aircraft, such as a rotorcraft. Gimbal assembly 230 couples the flight control device 200 to one or more flight control linkage 250 through a lever 255. Flight control linkage 250 is coupled to flight control devices (not shown), such as a rotorcraft swashplate or aircraft flight control surfaces. Gimbal assembly 230 allows a pilot or other operator to move flight control device 200 so that it rotates around a pitch axis 260 and/or a roll axis 270. Such movement of flight control device 200 then is transferred to the flight control surfaces through lever 255 and flight control linkage 250. For example, in a rotorcraft, movement of flight control device 200 translates all the way up to motion at the rotor system, which changes the attitude and direction of the rotorcraft.

The gimbal assembly 230 has a first function to hold that flight control device 200 in place and to act as the rotation point for the device. The secondary purpose of gimbal assembly 230 is to control friction in the system, which appears to an operator as “stiffness” associated with moving grip 210 and stick 220. A friction knob 280 may be configured such that twisting friction knob 280 applies friction to gimbal assembly 230 so that movement of flight control device 200 requires more force. In one embodiment, clockwise movement around axis 290 increases the friction applied by gimbal assembly 230 to flight control device 200, while turning friction knob 280 counter-clockwise around axis 290 decreases the friction applied by gimbal assembly 230. Therefore, when the friction applied by gimbal assembly 230 is increased, grip 210 may become harder to move; and when the friction applied by gimbal assembly 230 is decreased, grip 210 may become easier to move.

There may be several reasons why an adjustment of the friction by gimbal assembly 230 is preferable. For example, a pilot of rotorcraft 100 (FIG. 1) may desire to have the stiffness of flight control device 200 increased while rotorcraft 100 is hovering. This friction allows the pilot to release flight control device 200 during flight without concern that vibration or other movement of rotorcraft 100 will cause the flight control device 200 to move on its own, which would translate to movement of the rotor system or flight controls. It may also be preferable to increase the stiffness of flight control device 200 when certain components of rotorcraft 100 are being replaced or repaired.

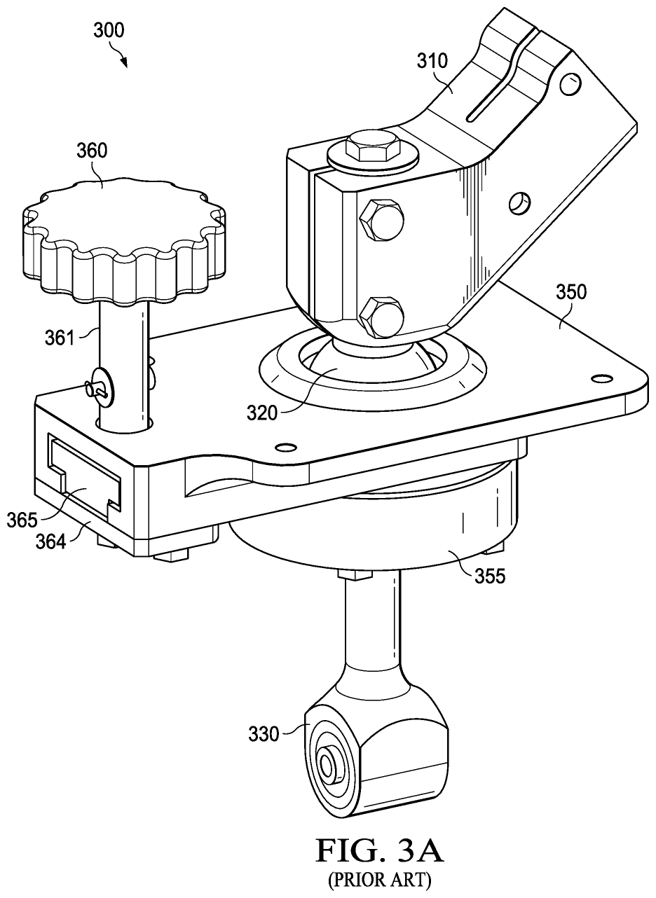

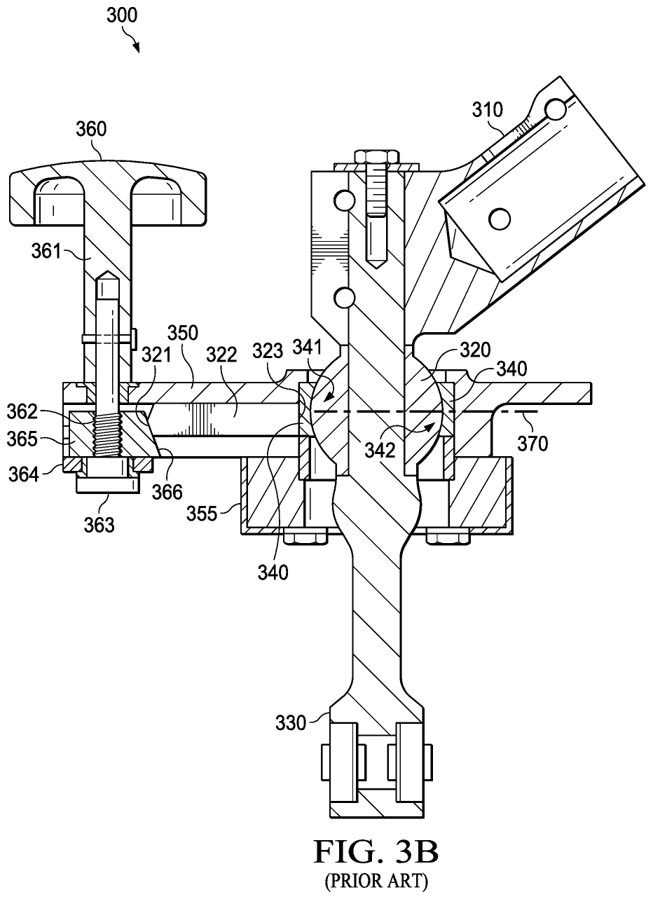

FIG. 3A depicts an example prior art cyclic stick support 300 with friction adjustment. FIG. 3B is a cross-section view of the prior art cyclic stick support 300 shown in FIG. 3A. A flight control stick coupling 310 is attached to the top of spherical bearing 320. Flight control stick coupling 310 is adapted to receive a flight control stick 220 and grip 210 assembly (FIG. 2). Lever 330 is coupled to the bottom of spherical bearing 320. Lever 330 may be coupled to one or more flight control linkages (not shown). Spherical bearing 320 is mounted in a bearing housing 340. The bearing housing 340 is mounted in base 350, which may be mounted on or under a rotorcraft floor or deck, for example. When flight control stick coupling 310 is rotated around spherical bearing 320, such movement is transferred to flight control linkages via lever 330. A cyclic stop 355 limits the range of motion of the flight control stick.

Friction is applied to cyclic stick support 300 using friction knob 360. Friction knob 360 has a stem 361 with a threaded portion 362. End portion 363 of stem 361 abuts plate 364 and prevents stem 361 from being removed from cyclic stick support 300 when friction knob 360 is moved. Friction wedge 365 is treaded to match threaded portion 362. When friction knob 360 is turned, stem 361 and threaded portion 362 also turn. The rotating threads on portion 362 cause wedge 365 to move upward or downward depending on which direction knob 360 is turned. Friction wedge 365 has a sloped surface 366 that pushes against a sloped surface 321 of bearing wedge 322. As friction wedge 365 is moved upward, sloped surface 366 moves against sloped surface 321, which causes bearing wedge 322 to move to the right in FIG. 3 toward bearing housing 340. This causes surface 323 of bearing wedge 322 to press against bearing housing 340 which creates a pinching force between bearing housing 340 and spherical bearing 320 at regions 341 and 342. The pinching force creates friction that limits movement of cyclic stick support 300.

Even though the configuration of cyclic stick support 300 has its advantages, such as limiting the movement of flight control stick coupling 310, it may also have some potential disadvantages. One potential disadvantage may be local “stiff” spots due to the mechanical system. For example, because bearing housing 340 applies force against spherical bearing 320 only at regions 341 and 342 to create friction, this may effectively create an axis 370 that spherical bearing 320 can more freely rotate around. Therefore, friction created in this manner is uneven, with the friction in the longitudinal stick direction always higher than in the lateral direction. Moreover, this configuration may be ineffective at holding a minimum friction setting, and a maximum friction setting may not be high enough. Because there can be potential disadvantages to using the friction system illustrated in FIGS. 3A and 3b to adjust the stiffness of a flight control device, there is a need for an improved flight control device which allows the stiffness to be more evenly distributed.

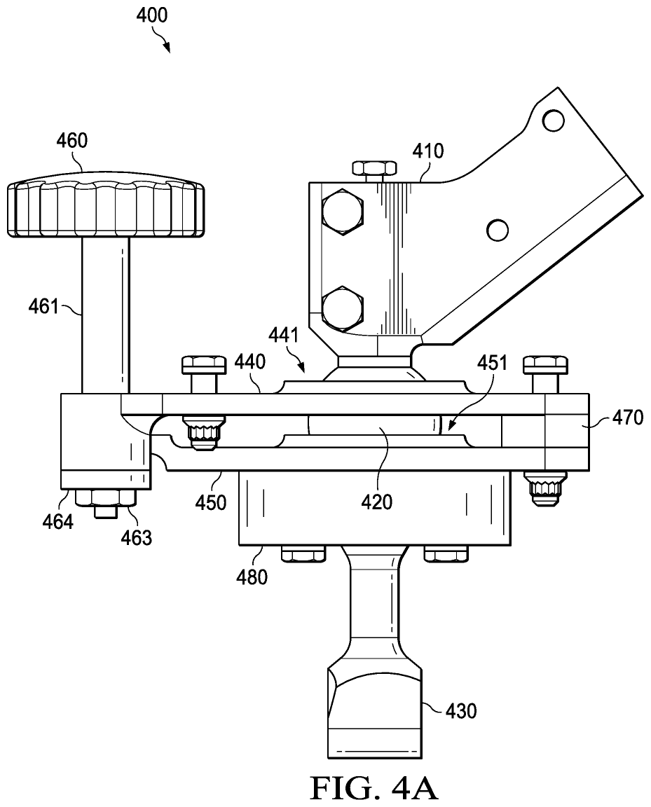

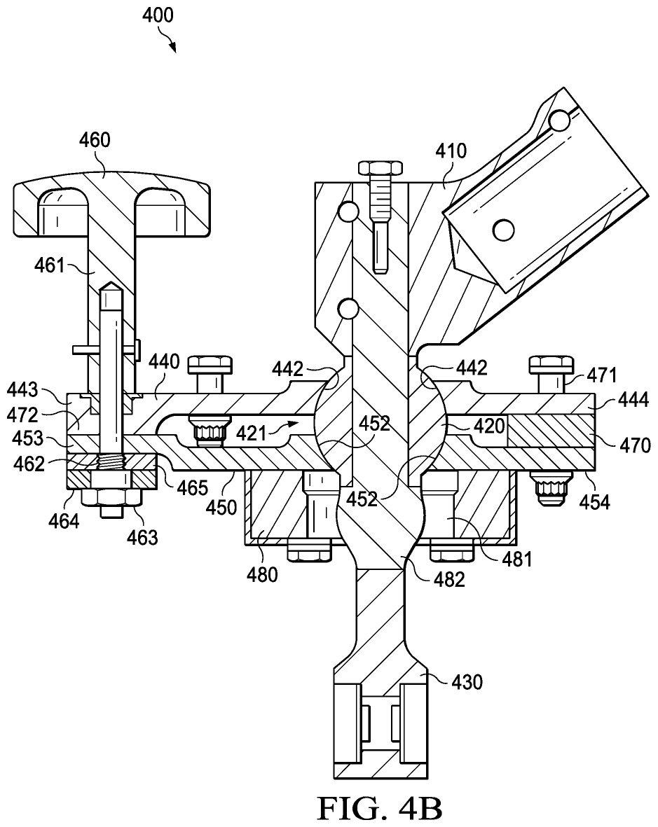

FIG. 4A depicts an example cyclic stick support 400 with improved friction adjustment according to one embodiment. FIG. 4B is a cross-section view of the cyclic stick support 400 shown in FIG. 4A. Flight control stick coupling 410 is attached to the top of spherical bearing 420. Lever 430 is coupled to the bottom of spherical bearing 420. Lever 430 may be coupled to one or more flight control linkages (not shown). Spherical bearing 420 is mounted between a top plate 440 and a bottom plate 450. The top plate 440 may be mounted on or under a rotorcraft floor or deck, for example. Top plate 440 has a hole 441 that is adapted to fit around the upper surface of spherical bearing 420. Similarly, bottom plate 450 has a hole 451 that is adapted to fit around the lower surface of spherical bearing 420. The top surface of spherical bearing 420 is held in place by inner wall 442 of hole 441, and the lower surface of spherical bearing 420 is held in place by inner wall 452 of hole 451 and may rotate in all directions. When flight control stick coupling 410 is rotated around spherical bearing 420, such movement is transferred to flight control linkages via lever 430.

Friction is applied to cyclic stick support 400 using friction knob 460. Friction knob 460 has a stem 461 with a threaded portion 462. End portion 463 of stem 461 abuts plate 464 and prevents stem 461 from being removed from cyclic stick support 400 when friction knob 460 is moved. Plate 465 is threaded to match threaded portion 462. When friction knob 460 is turned, stem 461 and threaded portion 462 also turn. The rotating threads on portion 462 cause plate 465 to move upward or downward depending on which direction knob 460 is turned. When friction knob 460 is turned to move plate 465 upward, then plate 465 causes end 453 of bottom plate 450 to also move upward toward end 443 of top plate 440. Spacer 470 holds end 444 of top plate 440 at a fixed distance from the corresponding end 454 of bottom plate 450. When end 453 of bottom plate 450 moves upward due to tightening of friction knob 460, the gap 421 between bottom plate 450 and top plate 440 is reduced. This movement also causes the inner walls 442, 452 of holes 441, 451 in top plate 440 and bottom plate 450, respectively, to clamp against spherical bearing 420 thereby creating friction.

The friction generated using the system illustrated in FIGS. 4A and 4B is fairly even in all directions because the inner walls 442, 452 of the holes 441, 451, respectively, encircle spherical bearing 420 and provide an even distribution of force around spherical bearing 420. The friction provided in cyclic stick support 400 is capable of generating a higher maximum friction compared to existing systems since more surface area touches spherical bearing 420 to apply friction force. Additionally, cyclic stick support 400 may hold a minimum friction setting better than existing systems.

Although a threaded knob 460 and bolt 462 are used to move the plates 440 and 450 closer together or farther apart in the example illustrated in FIGS. 4A and 4B, it will be understood that any other appropriate mechanical, electrical, or hydraulic device may be used to move plates 440 and 450. For example, a mechanical clamp, electric motor, or hydraulic actuator may be used to move plates 440 and 450 so that inner walls 442, 452 of holes 441, 451, respectively, may provide an evenly distributed, variable friction force against spherical bearing 420. Moreover, although FIGS. 4A and 4B illustrate a single clamping system (i.e., components 460-464) to move plates 440 and 450, it will be understood that in other embodiments, multiple devices may be used to position plates 440 and 450 and to adjust the distance therebetween.

Plates 440 and 450 may be configured to remain in a generally parallel arrangement in some embodiments. For example, plates 440 and 450 may move on rails, pins, or guides, such as bolts 462 and 471, so that the plates maintain a parallel relationship as the distance between plates 440 and 450 changes. Alternatively, plates 440 and 450 may hinge or pivot around a fixed point, such as spacer 470, when a clamping force is applied so that the distance between one end 443, 453 of each plate varies as the other end 444, 454 of each plate maintains a constant distance. In other embodiments, springs may be used in cyclic stick support 400 to push plates 440 and 450 apart in opposition to the clamping force applied by clamping system 460-464. For example, springs may be provided at location 472 and/or in place of spacer 470 to provide a force opposite to clamping system 460-464 so that plates 440 and 450 move quickly and freely as friction is applied or reduced.

In various configurations, either plate 440 or plate 450 may be considered to be in a fixed location, such as attached to the floor or deck of a rotorcraft cockpit. For example, if plate 440 is attached to the cockpit floor, then clamping system 460-464 would have the effect of pulling plate 450 upward to increase friction forces on spherical bearing 420. Alternatively, if plate 450 is attached to the cockpit floor, then clamping system 460-464 would have the effect of pulling plate 450 downward to increase friction forces on spherical bearing 420.

Cyclic stick support 400 further comprises a cyclic stop 480 coupled to plate 450. Cyclic stop 480 may be an annular ring having a hollow center region defined by an inner wall 481. A spherical bump stop 482 is coupled to the spherical bearing 420 and lever 430. Cyclic stop 480 may limit the movement of cyclic stick support 400. When bump stop 482 hits inner wall 481 due to movement of spherical bearing 420, the inner wall 481 and bump stop 482 prevent spherical bearing 420 from further movement in that direction. This effectively limits the degree of freedom and range of motion available to a stick attached to flight control stick coupling 410 and/or to flight control linkages attached to lever 430.

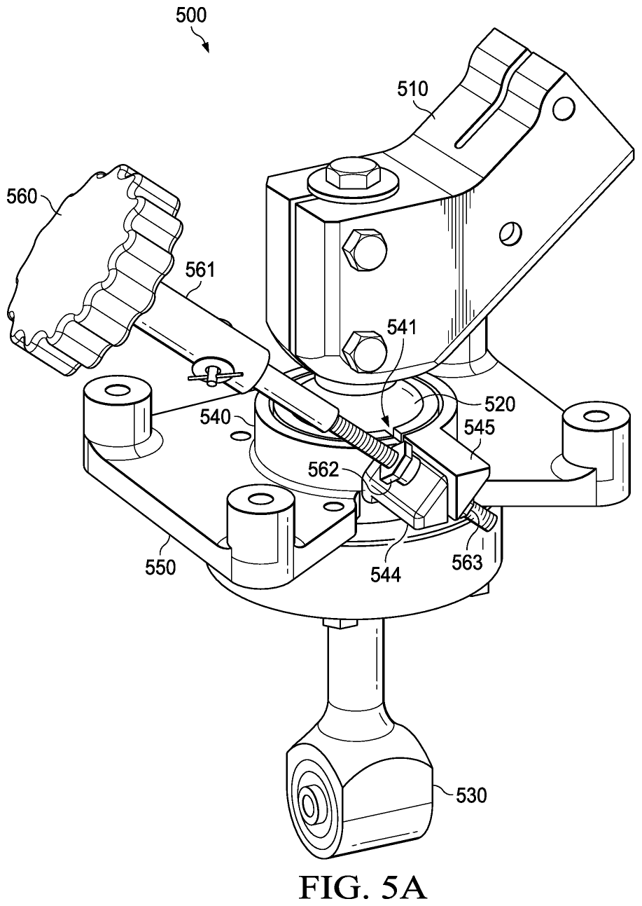

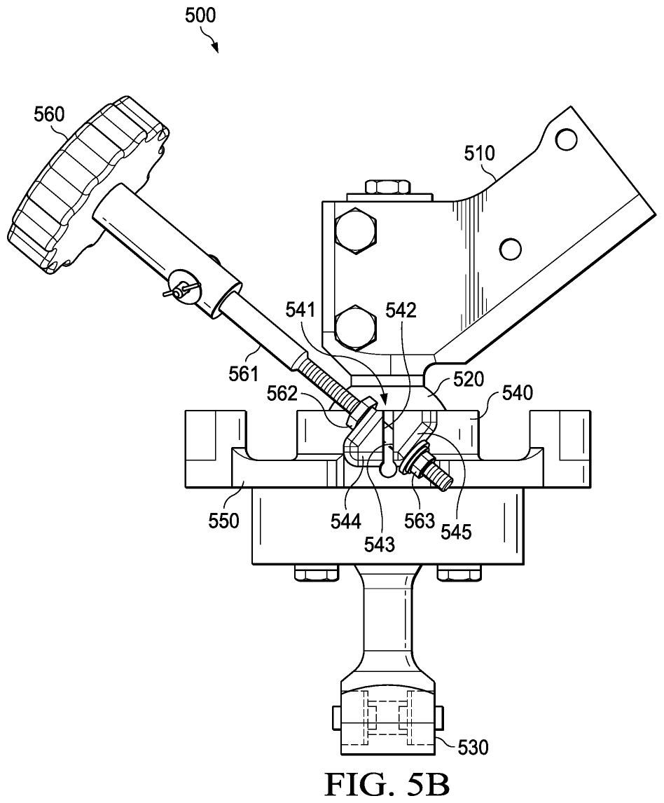

FIG. 5A depicts an example cyclic stick support 500 with improved friction adjustment according to an alternative embodiment. FIG. 5B is a side view of the cyclic stick support 500 shown in FIG. 5A. Flight control stick coupling 510 is attached to the top of spherical bearing 520. Lever 530 is coupled to the bottom of spherical bearing 520. Lever 530 may be coupled to one or more flight control linkages (not shown). Spherical bearing 520 is mounted in bearing housing ring 540, which is part of a base plate 550. The base plate 550 may be mounted on or under a rotorcraft floor or deck, for example. Bearing housing ring 540 is adapted to hold spherical bearing 520 bearing in place while allowing spherical bearing 520 to rotate in all directions. When flight control stick coupling 510 is rotated around spherical bearing 520, such movement is transferred to flight control linkages via lever 530.

Friction is applied to cyclic stick support 500 by adjusting a clamping force applied by bearing housing ring 540 to spherical bearing 520. Bearing housing ring 540 does not form a complete circle but has a gap 541 that is defined by edges 542 and 543. The inner diameter of bearing housing ring 540 can be reduced by closing gap 541—i.e., by moving edges 542 and 543 closer together. Reducing the inner diameter of bearing housing ring 540 would assert a clamping force on spherical bearing 520 thereby increasing the friction in cyclic stick support 500. Conversely, the inner diameter of bearing housing ring 540 can be increased by opening gap 541—i.e., by moving edges 542 and 543 farther apart. Increasing the inner diameter of bearing housing ring 540 reduces the clamping force on spherical bearing 520 thereby reducing friction.

In one embodiment, friction is applied using friction knob 560. Friction knob 560 has a stem 561 that passes through lugs 544 and 545 on bearing housing ring 540. Lugs 544 and 545 may be any bump, spur, tab, or projection that allow friction knob 560 and stem 561 to be connected to bearing housing ring 540. Lugs 544 and 545 may be integral components of bearing housing ring 540 or may be separate attachments to bearing housing ring 540. In one embodiment, lug 544 is threaded and lug 545 is unthreaded. In other embodiments, either lug 544 or lug 545 may be threaded. Jam nut 562 is attached to stem 561 at a point adjacent to lug 544. Nut 563 is attached to stem 561 at a point adjacent to lug 545.

Friction is controlled by turning knob 560, which causes lugs 544 and 545 to move toward each other or apart from each other. Movement of lugs 544 and 545 cause corresponding movement of edges 542 and 543 of bearing housing ring 540. The direction and degree to which lugs 544 and 545 move in response to turning knob 560 is determined by the direction and pitch of the threads in lug 544. In one embodiment, the threads are configured so that clockwise movement of knob 560 moves lugs 544 and 545 closer together. In this configuration, nut 563 presses up against unthreaded lug 545 causing the bearing housing ring clamp to close. Jam nut 562 on lug 544 may set a maximum amount that the bearing housing ring clamp can open, which also sets a minimum friction. As lugs 544 and 545 move together, the inner diameter of bearing housing ring 540 decreases, which applies a clamping force on spherical bearing 520 thereby generating friction.

The friction generated using the system illustrated in FIGS. 5A and 5B is even in all directions because the bearing housing ring 540 encircles spherical bearing 520 and provides an even distribution of force around spherical bearing 520. The friction provided in cyclic stick support 500 is capable of generating a higher maximum friction compared to existing systems since more surface area touches spherical bearing 520 to apply friction force. Additionally, cyclic stick support 500 may hold a minimum friction setting better than existing systems.

Although a knob 560 and threaded lug 544 are used to adjust gap 541 and to move edges 542 and 543 relative to each other in the example illustrated in FIGS. 5A and 5B, it will be understood that any other appropriate mechanical, electrical, or hydraulic device may be used to adjust gap 541. For example, a mechanical clamp, electric motor, or hydraulic actuator may be used to adjust gap 541 and to move edges 542 and 543 relative to each other so that bearing housing ring 540 may provide an evenly distributed, variable friction force against spherical bearing 520. Moreover, although FIGS. 5A and 5B illustrate a system using lugs 545 and 544 to adjust gap 541, it will be understood that in other embodiments the clamping device may be attached directly to bearing housing ring 540.

In one embodiment, a flight control device comprises a grip, a stick associated with the grip, and a gimbal. The gimbal comprising a spherical bearing coupled to the stick, a first plate having a first hole configured to receive a top portion of the spherical bearing, and a second plate having a second hole configured to receive a bottom portion of the spherical bearing. The first plate and the second plate are configured to move relative to each other to apply a variable force against the spherical bearing. The first hole further comprises a first inner surface, and the second hole comprises a second inner surface. The variable force against the spherical bearing is applied by mechanical interaction between the first and second inner surfaces and a surface of the spherical bearing.

The flight control device may further comprise a clamping device coupled to the first plate and the second plate. The clamping device is configured to move the first plate and the second plate relative to each other. The clamping device may comprise a knob portion configured to receive a bolt portion, wherein the knob is positioned to apply a force against the first plate and the bolt portion is positioned to apply a force against the second plate, and wherein turning the knob portion in a first direction reduces a distance between the first plate and the second plate. Turning the knob portion in a second direction opposite the first direction increases the distance between the first plate and the second plate. The clamping device may be selected from a mechanical clamp, an electronic motor, and a hydraulic actuator.

The first plate and the second plate may be configured to remain in a generally parallel relationship as they move relative to each other.

In a further embodiment, a first end of the first plate and a first end of the second plate are configured to remain at a fixed distance from each other. A second end of the first plate and a second end of the second plate are configured to move relative to each other to apply a variable force against the spherical bearing.

The flight control device may further comprise a lever coupled to the spherical bearing at a position opposite to the stick. The lever may be configured to be coupled to a flight control linkage. A cyclic stop may be coupled to the second plate. A bump stop may be coupled to the spherical bearing and the lever, wherein the cyclic stop and the bump stop are configured to limit a range of motion of the spherical bearing.

In another embodiment, a flight control stick support comprises a spherical bearing coupled to a flight control stick, a first plate having a first hole configured to receive a top portion of the spherical bearing, a second plate having a second hole configured to receive a bottom portion of the spherical bearing, and a clamping device configured to move the first plate relative to and the second plate to apply a variable force against the spherical bearing.

The first hole may comprise a first inner surface, and the second hole may comprise a second inner surface. The variable force against the spherical bearing is applied by mechanical interaction between the first and second inner surfaces and a surface of the spherical bearing.

The clamping device may be configured to apply a variable amount of stiffness to the flight control stick.

The clamping device may comprise a knob portion configured to receive a bolt portion, wherein the knob is positioned to apply a force against the first plate and the bolt portion is positioned to apply a force against the second plate, and wherein turning the knob portion in a first direction reduces a distance between the first plate and the second plate. Turning the knob portion in a second direction opposite the first direction increases the distance between the first plate and the second plate.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A flight control device, comprising:
a grip;
a stick associated with the grip; and
a gimbal comprising:
a spherical bearing coupled to the stick;
a first plate having a first hole configured to receive a top portion of the spherical bearing; and
a second plate having a second hole configured to receive a bottom portion of the spherical bearing, wherein the first plate and the second plate are configured to move relative to each other to apply a variable force against the spherical bearing.

2. The flight control device of claim 1, wherein the first hole further comprises a first inner surface, and the second hole comprises a second inner surface, wherein the variable force against the spherical bearing is applied by mechanical interaction between the first and second inner surfaces and a surface of the spherical bearing.

3. The flight control device of claim 1, further comprising:
a clamping device coupled to the first plate and the second plate, wherein the clamping device is configured to move the first plate and the second plate relative to each other.

4. The flight control device of claim 3, wherein the clamping device comprises:
a knob portion configured to receive a bolt portion, wherein the knob is positioned to apply a force against the first plate and the bolt portion is positioned to apply a force against the second plate, and wherein turning the knob portion in a first direction reduces a distance between the first plate and the second plate.

5. The flight control device of claim 4, wherein turning the knob portion in a second direction opposite the first direction increases the distance between the first plate and the second plate.

6. The flight control device of claim 3, wherein the clamping device comprises a device selected from a mechanical clamp, an electronic motor, and a hydraulic actuator.

7. The flight control device of claim 1, wherein the first plate and the second plate are configured to remain in a generally parallel relationship as they move relative to each other.

8. The flight control device of claim 1, wherein a first end of the first plate and a first end of the second plate are configured to remain at a fixed distance from each other, and wherein a second end of the first plate and a second end of the second plate are configured to move relative to each other to apply a variable force against the spherical bearing.

9. The flight control device of claim 1, further comprising:
a lever coupled to the spherical bearing at a position opposite to the stick, the lever configured to be coupled to a flight control linkage.

10. The flight control device of claim 9, further comprising:
a cyclic stop coupled to the second plate; and
a bump stop coupled to the spherical bearing and the lever, wherein the cyclic stop and the bump stop are configured to limit a range of motion of the spherical bearing.

11. A flight control stick support, comprising:
a spherical bearing coupled to a flight control stick;
a first plate having a first hole configured to receive a top portion of the spherical bearing;
a second plate having a second hole configured to receive a bottom portion of the spherical bearing; and
a clamping device configured to move the first plate relative to and the second plate to apply a variable force against the spherical bearing.

12. The flight control stick support of claim 11, wherein the first hole further comprises a first inner surface, and the second hole comprises a second inner surface, wherein the variable force against the spherical bearing is applied by mechanical interaction between the first and second inner surfaces and a surface of the spherical bearing.

13. The flight control stick support of claim 11, wherein the clamping device is configured to apply a variable amount of stiffness to the flight control stick.

14. The flight control stick support of claim 11, wherein the clamping device comprises:
a knob portion configured to receive a bolt portion, wherein the knob is positioned to apply a force against the first plate and the bolt portion is positioned to apply a force against the second plate, and wherein turning the knob portion in a first direction reduces a distance between the first plate and the second plate.

15. The flight control stick support of claim 14, wherein turning the knob portion in a second direction opposite the first direction increases the distance between the first plate and the second plate.

16. The flight control stick support of claim 11, wherein the clamping device comprises a device selected from a mechanical clamp, an electronic motor, and a hydraulic actuator.

17. The flight control stick support of claim 11, wherein the first plate and the second plate are configured to remain in a generally parallel relationship as they move relative to each other.

18. The flight control stick support of claim 11, wherein a first end of the first plate and a first end of the second plate are configured to remain at a fixed distance from each other, and wherein a second end of the first plate and a second end of the second plate are configured to move relative to each other to apply a variable force against the spherical bearing.

19. The flight control stick support of claim 11, further comprising:
a lever coupled to the spherical bearing at a position opposite to the stick, the lever configured to be coupled to a flight control linkage.

20. The flight control stick support of claim 19, further comprising:
a cyclic stop coupled to the second plate; and
a bump stop coupled to the spherical bearing and the lever, wherein the cyclic stop and the bump stop are configured to limit a range of motion of the spherical bearing.
